(19) United States
(12) Patent Application Publication
(10) Pub. No.: US 2015/0069782 A1
(43) Pub. Date: Mar. 12, 2015

(54) Modular Window System for Passenger Vehicle

(71) Applicant: Winnebago Industries, Inc., Forest City, IA (US)

(72) Inventors: Randy Potts, Forest City, IA (US); Steve Monk, Forest City, IA (US); Keith Kearns, Clear Lake, IA (US); Al Heimdal, Forest City, IA (US); Mark Stumme, Forest City, IA (US)

(21) Appl. No.: 14/482,897

(22) Filed: Sep. 10, 2014

Related U.S. Application Data
(60) Provisional application No. 61/876,028, filed on Sep. 10, 2013.

(51) Int. Cl. B60J 1/00; B62D 25/07; B62D 31/02

(52) U.S. Cl. CPC B60J 1/007; B62D 31/02; B62D 25/07
USPC 296/178

(57) ABSTRACT

The disclosure relates to apparatus, systems and methods for assembling a passenger vehicle including an improved system for modular window assemblies on passenger vehicles, such as busses. These passenger vehicles feature a unified roof component and modular window units which are configured to be installed directly onto the frame such that the roof and sidewall are correspondingly joined by way of joints. In further implementations, a forward transition region is installed which is also fixedly attached to the unified roof component by way of an H section joint.

### CROSS-REFERENCE TO RELATED APPLICATION(S)

This application claims priority from U.S. Provisional Application 61/876,028, filed Sep. 10, 2013, and entitled “Modular Window System for Passenger Vehicle,” which is hereby incorporated herein by reference in its entirety.

### FIELD OF THE INVENTION

The disclosed apparatus, methods and system relate to an improved and methods novel passenger vehicle including a window assembly.

### BACKGROUND OF THE INVENTION

The presently disclosed embodiments relate to various apparatus, systems and methods relating to a modular window design for passenger vehicles.

Prior art designs for windows frequently feature clamp ring and flange designs, which are inefficient and frequently leak, causing undesirable water flow into the body of the vehicle. As a result, typical passenger vehicle designs feature a “drip rail,” or other awning-style means to attempt to prevent liquid from entering the cabin of the vehicle. Further, typical passenger vehicles are frequently assembled by forming the body and then cutting window holes to place the windows in.

Prior designs also frequently are assembled with seams that run vertically over the top of the roof to accommodate the front and rear transition portions, which also create a host of leakage and other problems. The presently disclosed apparatus, systems and methods disclose a novel passenger vehicle system which addresses these flaws in the prior art.

### BRIEF SUMMARY OF THE INVENTION

As discussed herein, the “window assembly” relates to various apparatus, systems and methods relating to a novel roof and window assembly of a passenger vehicle, such as a bus. While various embodiments will be referred to herein as “the window assembly” or “the roof assembly” for brevity, these apparatus, systems and methods are all contemplated. The window assembly acts to prevent water leaks through the windows of the vehicle, and to allow for the installation of windows into the frame later in construction.

The disclosure relates to apparatus, systems and methods for assembling a passenger vehicle including an improved system for modular window assemblies on passenger vehicles, such as busses. These passenger vehicles feature a unified roof component and modular window units which are configured to be installed directly onto the frame such that the roof and sidewall are correspondingly joined by way of joints. In further implementations, a forward transition region is installed which is also fixedly attached to the unified roof component by way of an H section joint.

While multiple embodiments are disclosed, still other embodiments of the window assembly will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of a passenger vehicle comprising the window assembly, according to an exemplary embodiment.

FIG. 2 is a further perspective side view of the embodiment of FIG. 1.

FIG. 3 is a reverse side vide of the embodiment of FIGS. 1-2.

FIG. 4A is a front view of a passenger vehicle with the window assembly, according to an exemplary embodiment.

FIG. 4B is the back view of the embodiment of FIG. 4A.

FIG. 5 is a perspective view of the frame of the window assembly, according to one embodiment.

FIG. 6A is a perspective view of an exemplary embodiment of the window assembly wherein the frame is mounted on a chassis in assembly.

FIG. 6B is another perspective view of the embodiment of FIG. 6A, further showing an embodiment of the forward transition.

FIG. 7A is a perspective view of the frame assembled and attached to the chassis, according to an exemplary embodiment.

FIG. 7B is a interior view of the frame with the unified roof component mounted in place, according to an exemplary embodiment.

FIG. 7C is a side view of the modular window openings fit around the frame's cage tubes, according to one embodiment.

FIG. 7D depicts an exemplary embodiment comprising a retainer, or “inner cap” to lock the modular windows in place.

FIG. 8 depicts yet another perspective view of the forward transition installed on the chassis, according to one embodiment.

FIG. 9A is a rear perspective view of one embodiment of the unified roof component.

FIG. 9B is a rear perspective view of the embodiment of FIG. 9A, wherein the unified roof component has been placed on the frame.

FIG. 10 is a cross section of one embodiment of the window assembly showing the unified roof component transition joint with the forward transition, comprising the H section.

FIG. 11 is a further cross-sectional view of the assembly showing the wedge shaped member, according to an exemplary embodiment.

FIG. 12A is an endlong perspective view of one embodiment of the wedge shaped member.

FIG. 12B is a further endlong perspective view of the wedge shaped member, according to the embodiment of FIG. 12A.

FIG. 13 is a side view of the transition joint, according to an exemplary embodiment.

FIG. 14 is a further perspective view of the window assembly, according to an exemplary embodiment.

FIG. 15 is an internal view of the embodiment of FIG. 14.

FIG. 16 is a cross-sectional view of the window assembly, showing the window joints, windows, and mulling, according to an exemplary embodiment.

FIG. 17 is a detailed view of the top window joint portion of the embodiment of FIG. 16.

FIG. 18 is a detailed view of the central, mulling portion of FIG. 16.

FIG. 19 is a detailed view of the bottom window joint portion of the embodiment of FIG. 16.

FIG. 20 is a transverse view of the embodiment of FIG. 16.

FIG. 21 detailed perspective view of the transition from the H section of the forward transition region to the window assembly region joint, according to an exemplary embodiment.

### DETAILED DESCRIPTION

Prior art designs for windows frequently feature clamp ring and flange designs, which are inefficient and frequently leak, causing undesirable water flow into the body of the vehicle. As a result, typical passenger vehicle designs feature a “drip rail,” or other awning-style means to attempt to prevent liquid from entering the cabin of the vehicle. Further, typical passenger vehicles are frequently assembled by forming the body and then cutting window holes to place the windows in. Prior designs also frequently are assembled with seams that run vertically over the top of the roof to accommodate the front and rear transition portions, which also create a host of leakage and other problems. The present apparatus, systems and methods disclose a novel passenger vehicle window and roof assembly which addresses these flaws in the prior art.

The window assembly unit seeks to address these issues in the prior art by providing a modular window assembly and unified roof for a passenger vehicle. In exemplary implementations, the vehicle features a chassis, a frame mounted on the chassis, a generally rectangular unified roof component further comprising front and back ends and side portions a top window joint, a bottom window joint, a sidewall and at least one modular window unit further comprising a top and bottom, such that the at least one modular window unit is disposed between the sides of the unified roof component and sidewalls by way of the top window joint and bottom window joint. Certain exemplary implementations further comprise an H section joint and forward transition region, wherein the transition is fixedly attached to the chassis, wherein the H section joint is disposed between the unified roof component and the transition region.

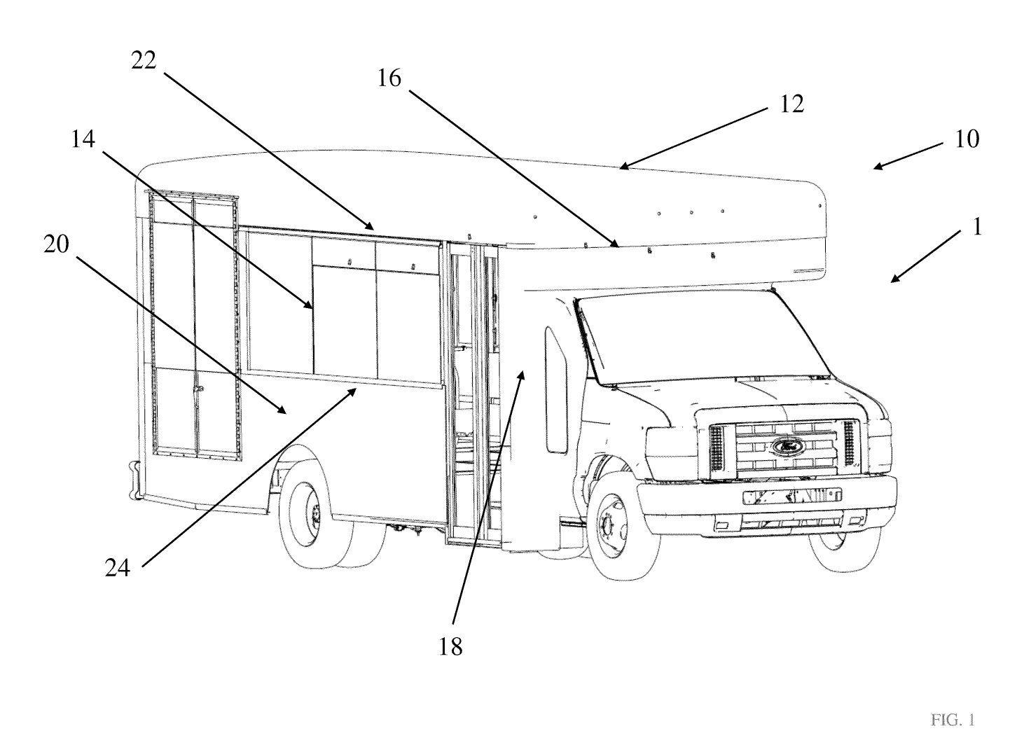

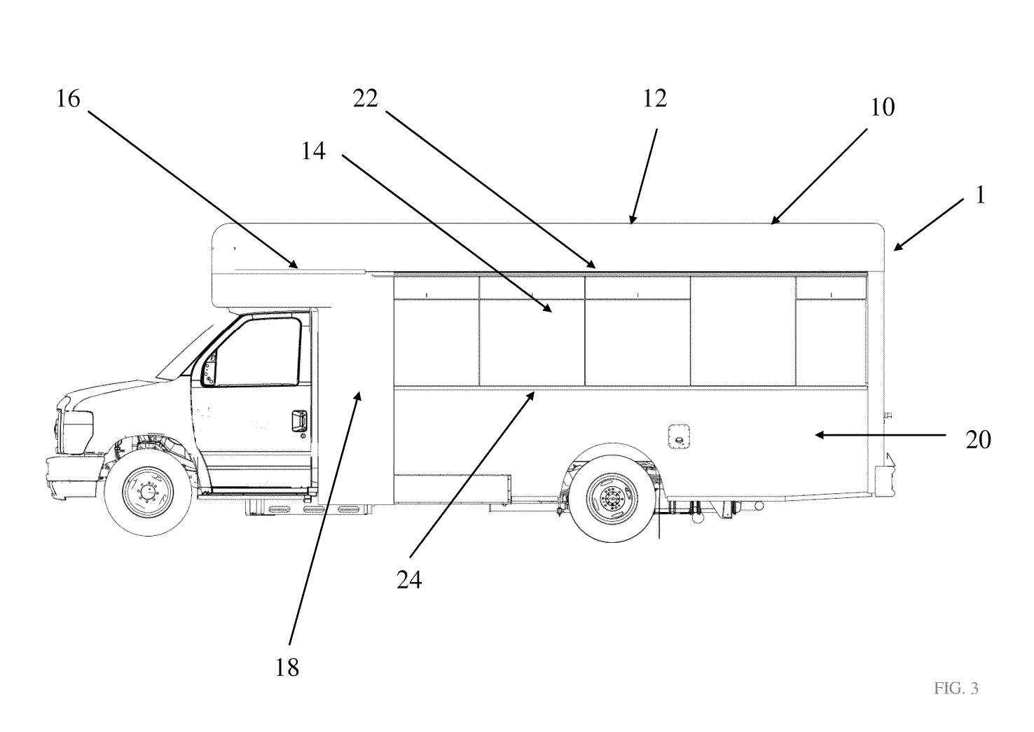

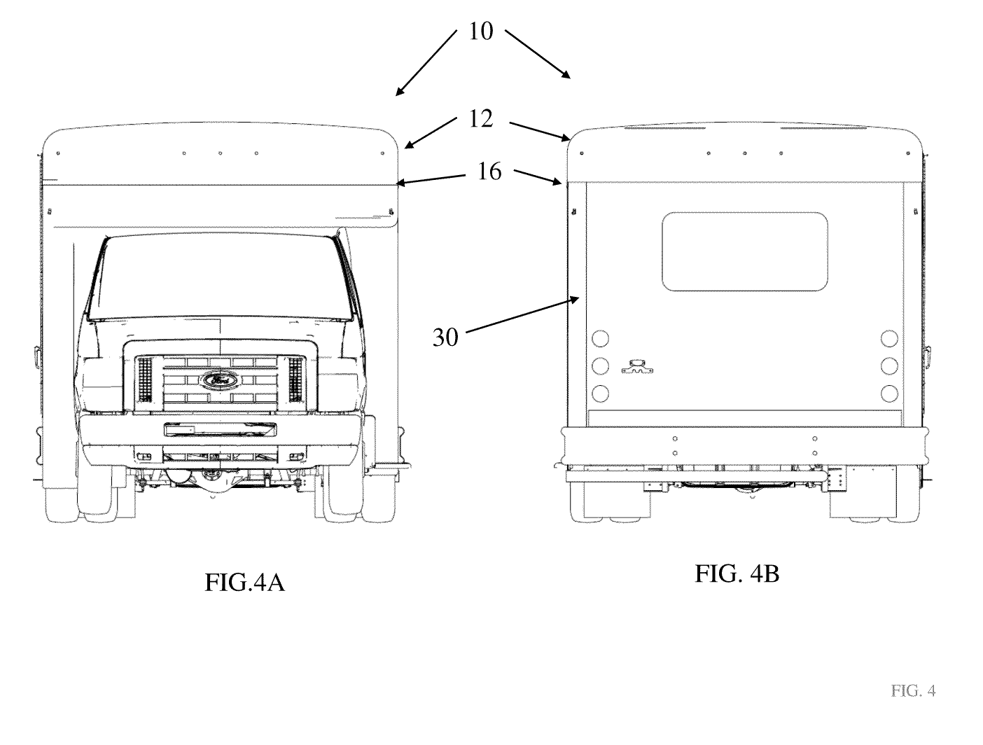

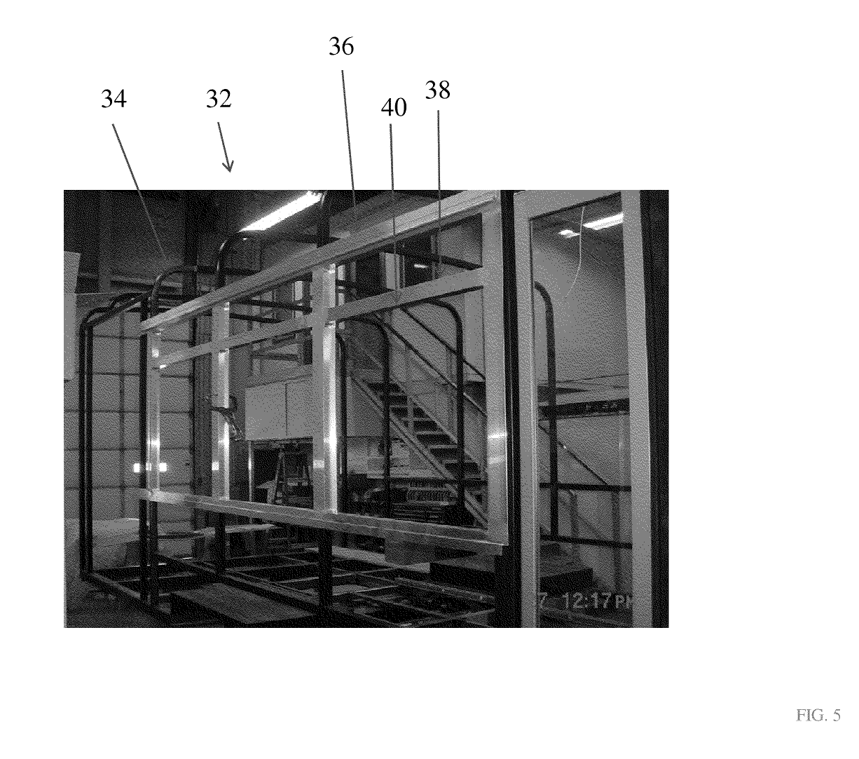

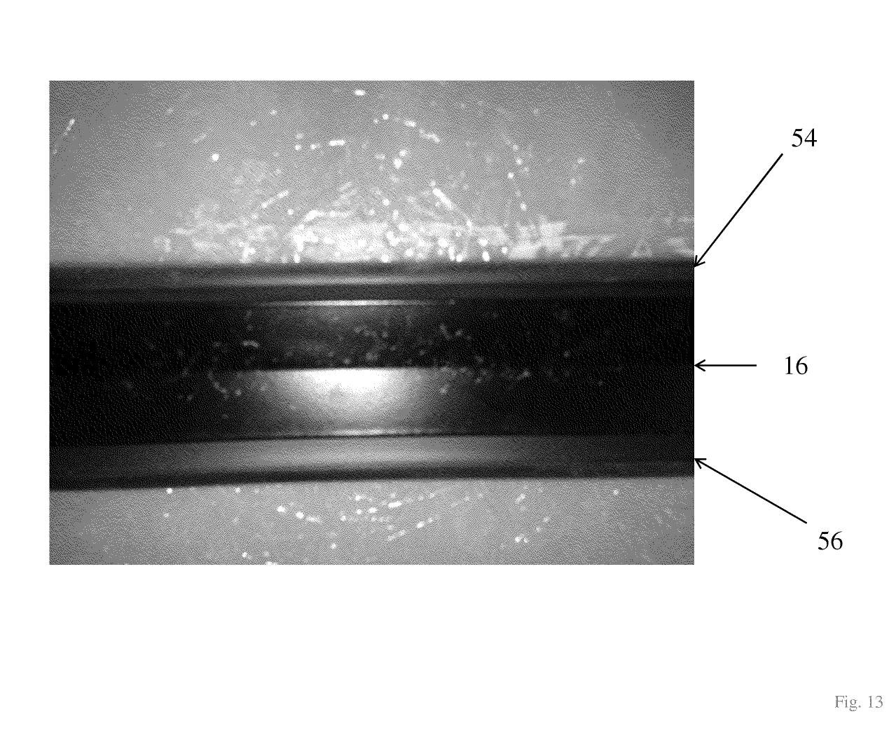

Referring now to the figures with particularity, FIGS. 1-4 depict various views of vehicles 1 comprising exemplary embodiments of the window assembly 10. These embodiments generally comprise a novel unified roof component 12, at least one modular window unit 14, and window joints, or transition regions 22, 24. In these embodiments, the present apparatus systems and methods allow for a window assembly in which window units can be completely assembled separate from the vehicle and installed when vehicle manufacture has neared or reached completion. FIGS. 5-16 depict various views of the assembly of the vehicle according to the present disclosure according to exemplary embodiments. As would be apparent to one of skill in the art, the present system can be scaled to be utilized on vehicles of various other sizes and configurations.

Turning to the figures in detail, FIGS. 1-4B depict external views of a passenger vehicle 1 utilizing an exemplary embodiment of the present system 10. In these embodiments, the window assembly 10 further comprises a generally rectangular unified roof component 12, modular window units 14, an “H section” joint 16, a forward transition region 18, a sidewall 20, and window transition regions 22, 24. While fiberglass is typically used for the forward transition region and sidewall in these embodiments, other building materials may be utilized.

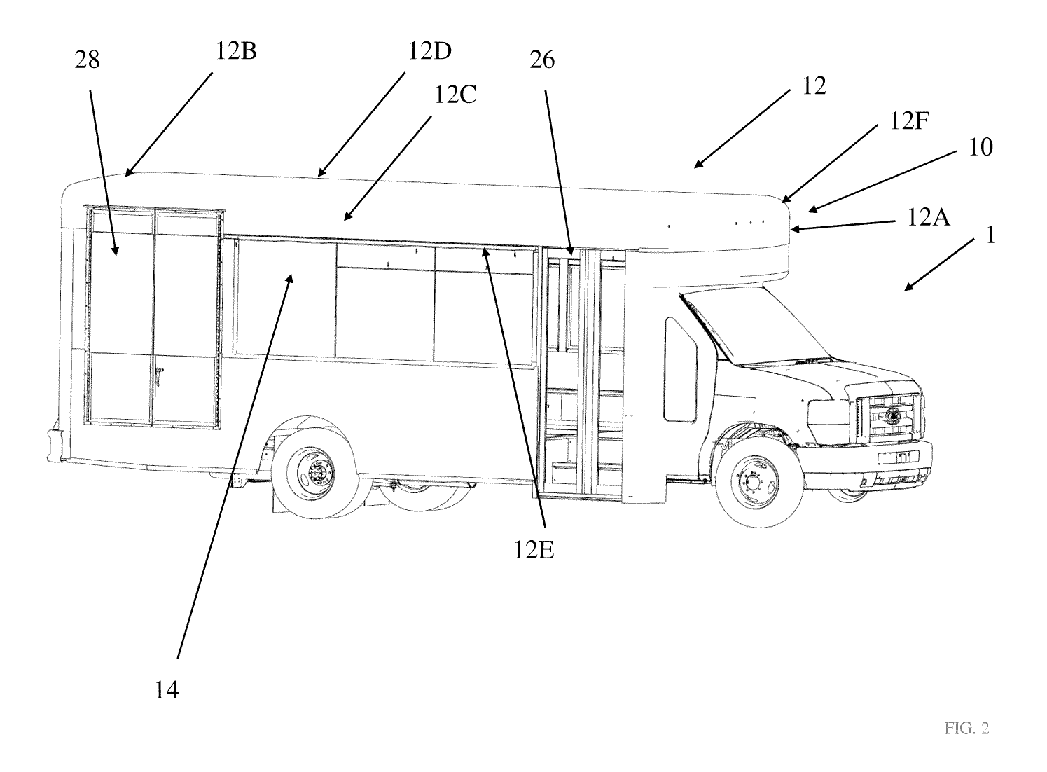

As depicted in FIG. 2, in certain embodiments, the unified roof component 12 further comprises generally square front 12A and back 12B ends side portions 12C, a top 12D and bottom 12E, and generally rounded corners 12F. In certain embodiments, the window joints 22, 24 are attached between a side portion 12C and the modular window units 14.

As depicted in FIGS. 1-4B, in addition to the unified roof component 12, exemplary embodiments the window assembly also comprise an “H-Section” joint 16, forward transition 18 and a rear portion 30. In certain embodiments, the rear portion is fiberglass as well. In certain exemplary embodiments, the forward transition region 18 is configured to be fixedly attached to the underside, or bottom 12E portion of the unified roof component, by way of the H section joint 16. In these embodiments the H-Section 16 allows the vehicle 1 to be assembled such that the unified roof component 12 seam (at 16) is substantially horizontal to the ground, which is a substantial improvement over the prior art models, which feature vertical seams. The embodiments featuring an H-Section present significant additional improvements over the prior art, and are described herein below.

Further, in certain embodiments the window assembly 10 can further comprise openings for entrance doors 26 and lift access doors 28 on at least one side of the vehicle 1, as is best shown in FIG. 2. Various vehicle embodiments can also comprise other means of ingress and egress, as would be apparent to one of skill in the art.

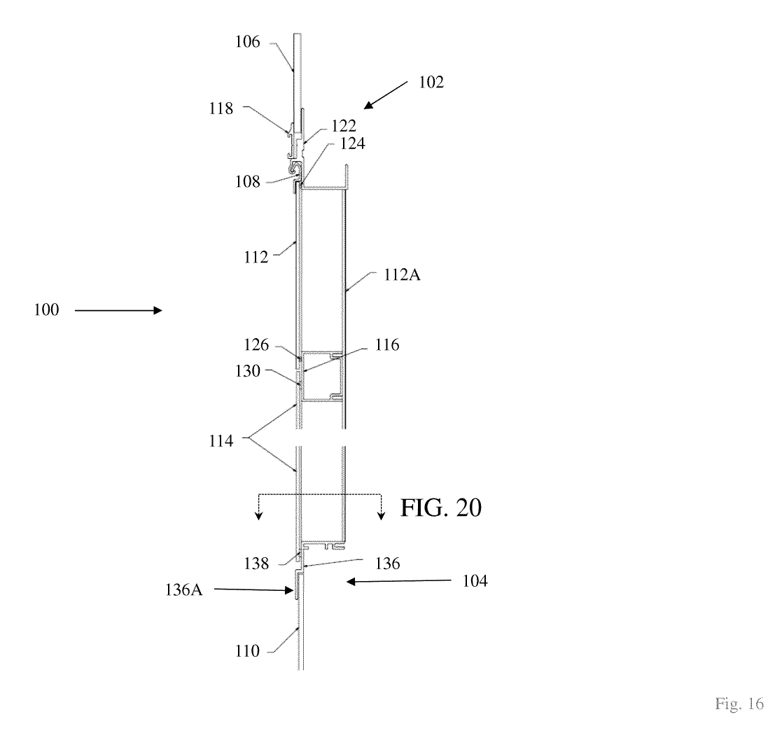

As depicted in FIGS. 5-7, exemplary embodiments of the window assembly 10 comprise a frame 32, which the completed assembly is fixedly attached to. In certain embodiments, and as shown generally in FIG. 5, the frame 32 features a roll cage structure 34 and at least one modular window frame 36 having at least one modular window opening 38. The modular window opening 38 can further comprise novel extrusions 40 (described in detail herein with reference to FIGS. 16-19).

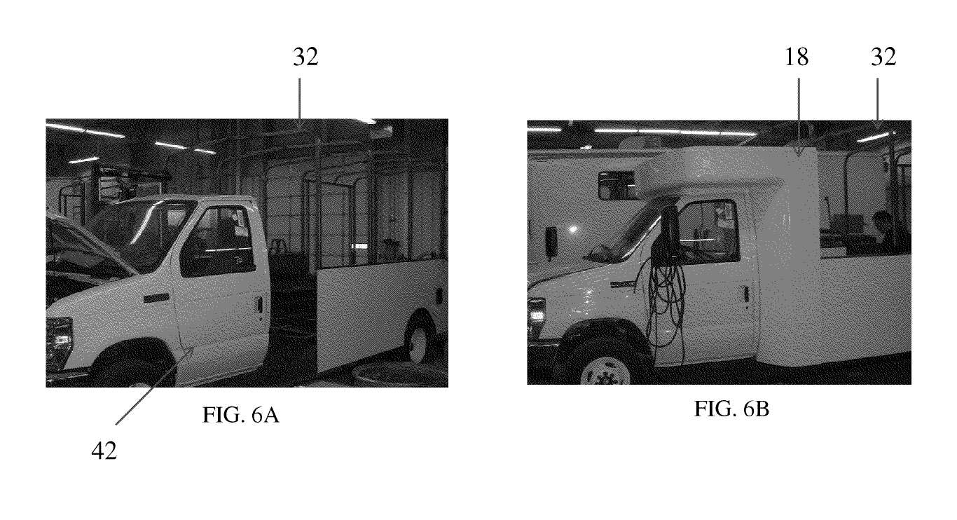

FIGS. 6A-6B show an exemplary embodiment of the window assembly 10 wherein the frame 32 is mounted on a chassis 42 in assembly. In these embodiments, the forward transition 18 is also mounted on the chassis 42 such that the frame 32 and forward transition 18 are aligned to accept the unified roof component (not shown). As a result, in these implementations are configured such that the roof component is disposed above the forward transition by way of the H section joint so as to prevent leakage and accommodate easier assembly.

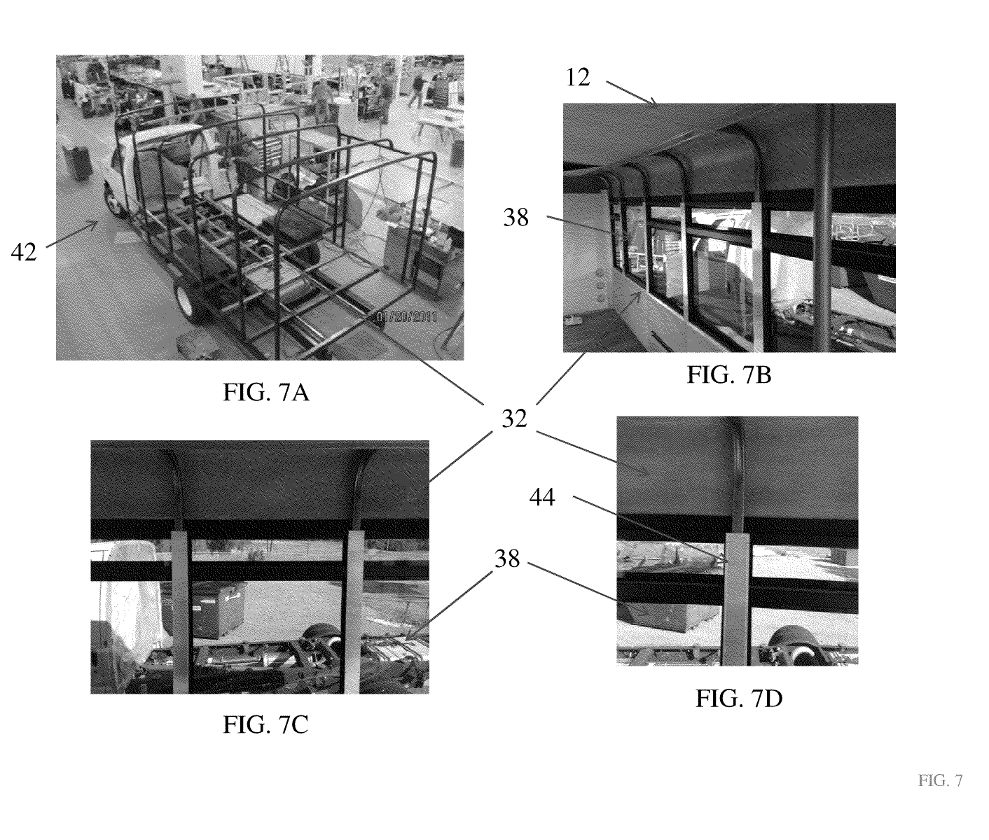

FIGS. 7A-7D depict various views of the frame 32, modular window openings 38 and unified roof component 12 set into the body of the vehicle during assembly. FIG. 7A depicts the frame 32 assembled and attached to the chassis 42. FIG. 7B depicts an interior view of the frame 32 with the unified roof component 12 mounted in place, and awaiting window installation. As is shown in FIG. 7C, the modular window openings 38 fit around the frame's cage tubes. FIG. 7D depicts an exemplary embodiment comprising a retainer, or “inner cap” 44 to lock the modular windows in place.

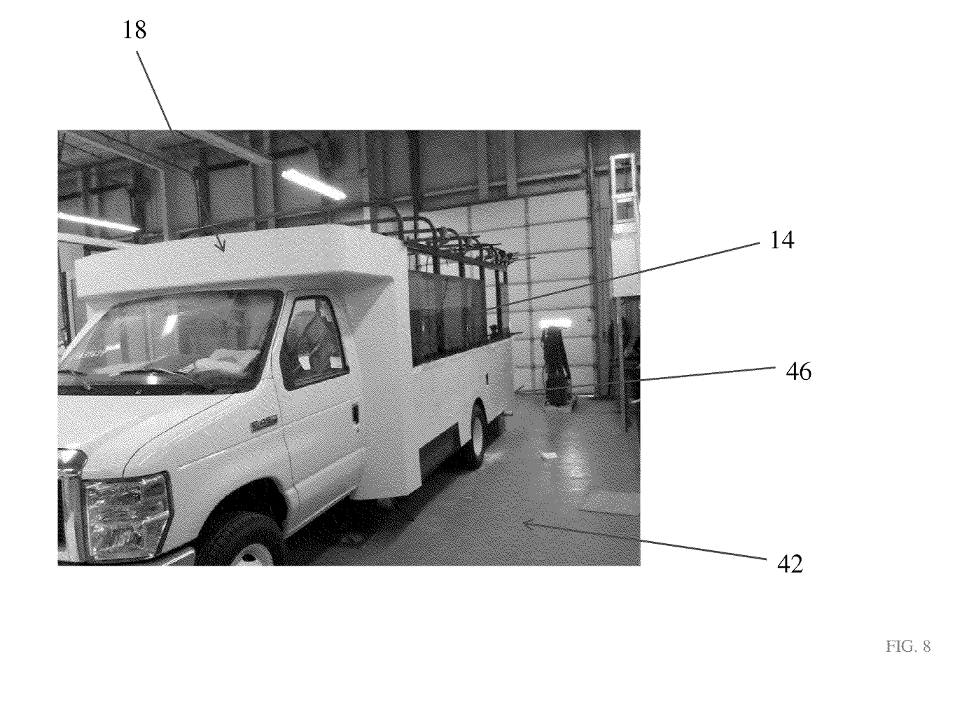

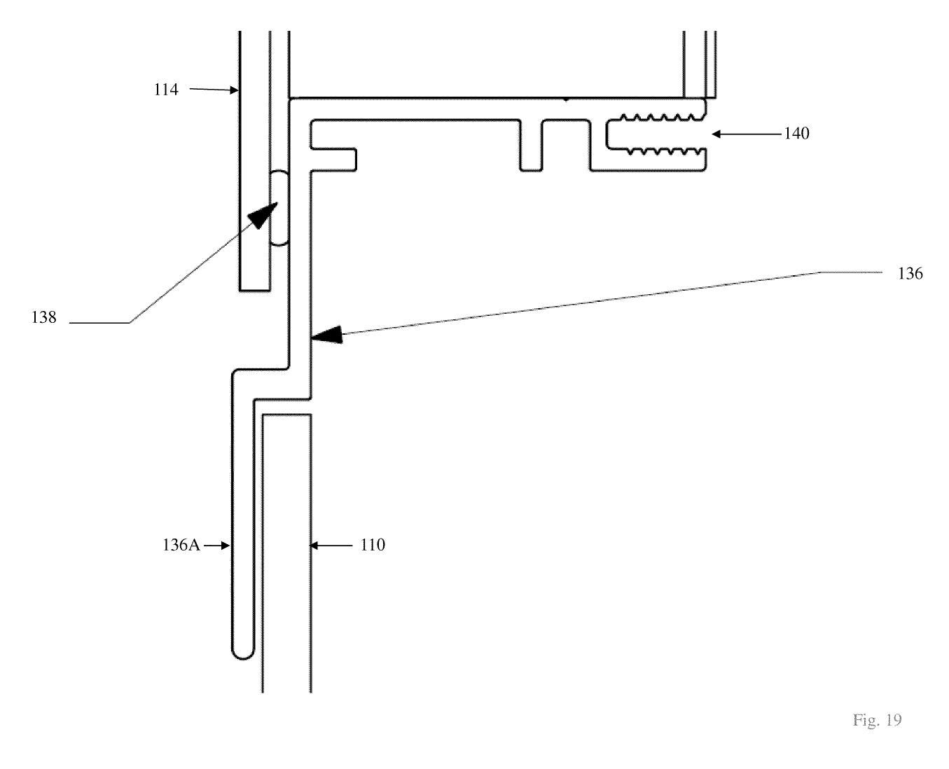

FIG. 8 shows yet another view of the forward transition 18 installed on the chassis 42. In this embodiment, modular window units 14 have been installed on the frame 32 such that they overlap the lower sidewall skin 46. In these embodiments, the fiberglass skin 46 may be coupled to the window units as described in reference to FIG. 19.

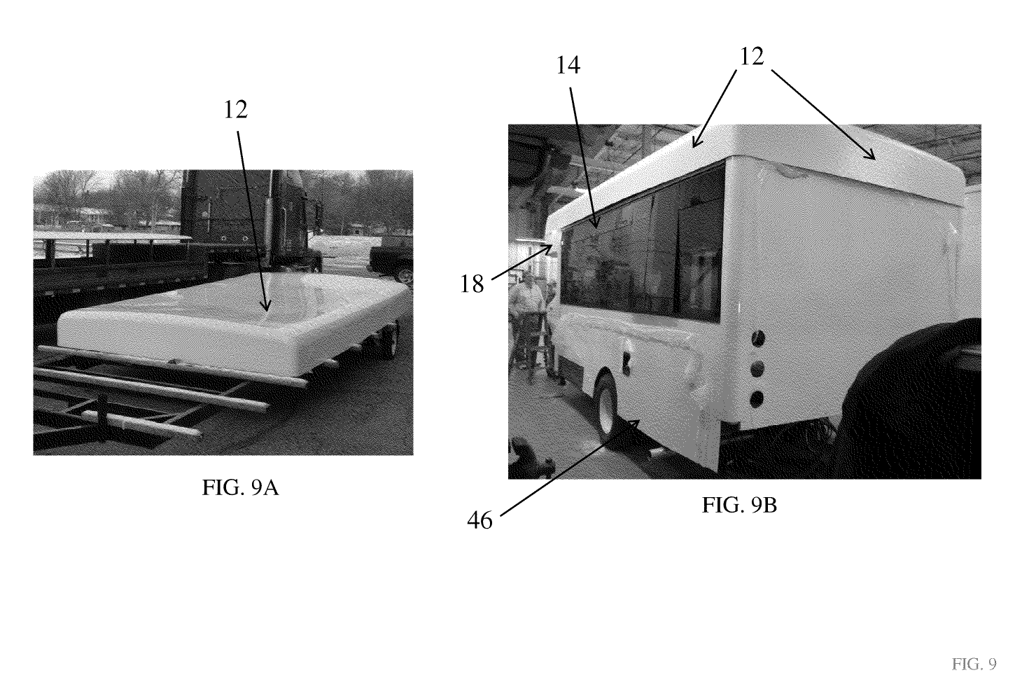

FIGS. 9A-9B depict yet further views of the unified roof component 12. In certain embodiments, the unified roof component 12 installed on top of the chassis 42 in direct contact with the forward transition 18 and modular window units 14, and apart from the lower sidewall fiberglass skin 46, as described in reference to FIGS. 16-19. The unified roof component 12 is then clamped into place. FIG. 9A shows the unified roof component 12 before being mounted on the chassis, while FIG. 9B depicts the roof mounted on the chassis 42 but not yet clamped into place. In certain embodiments, adhesive is also employed to affix the unified roof component to the frame bows or roll cage.

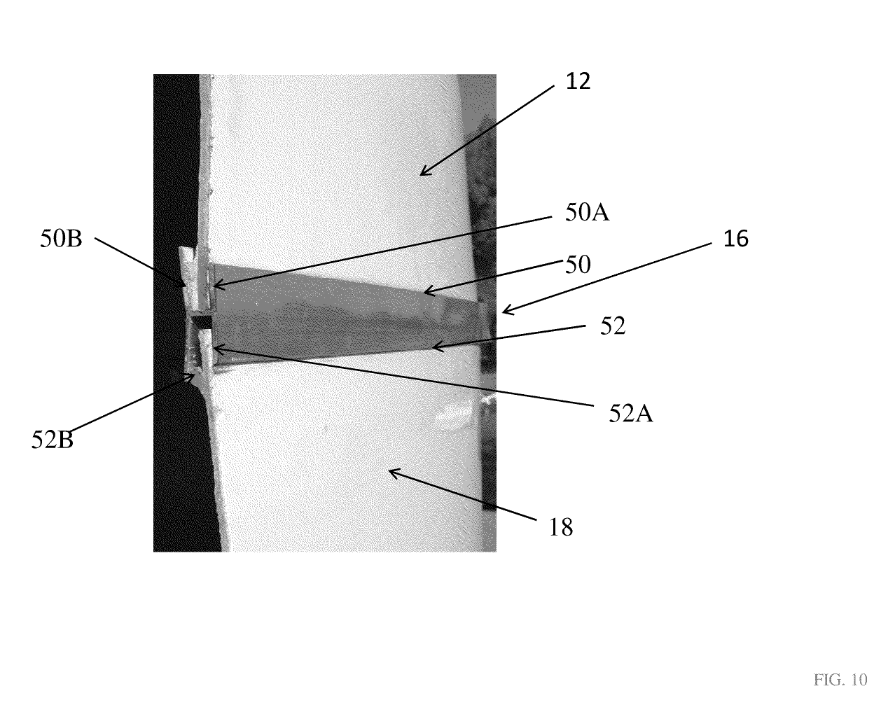

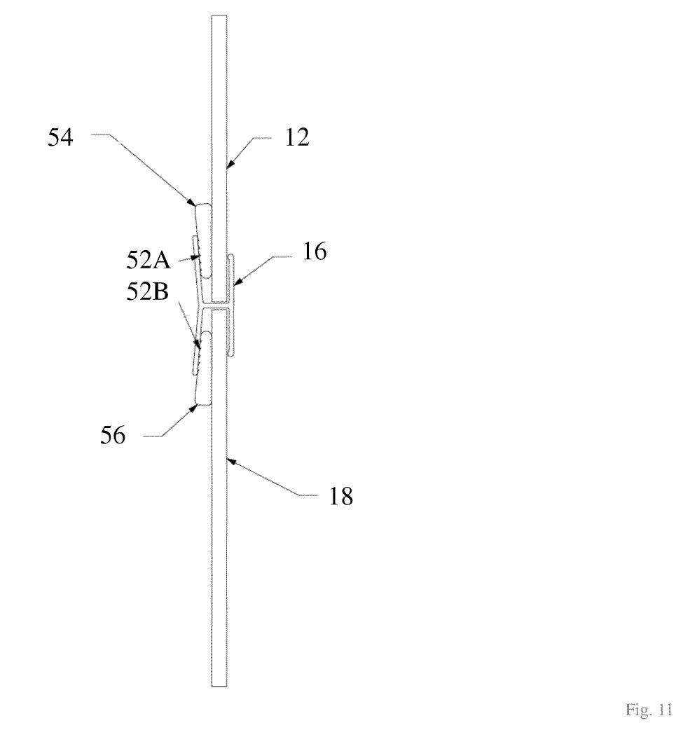

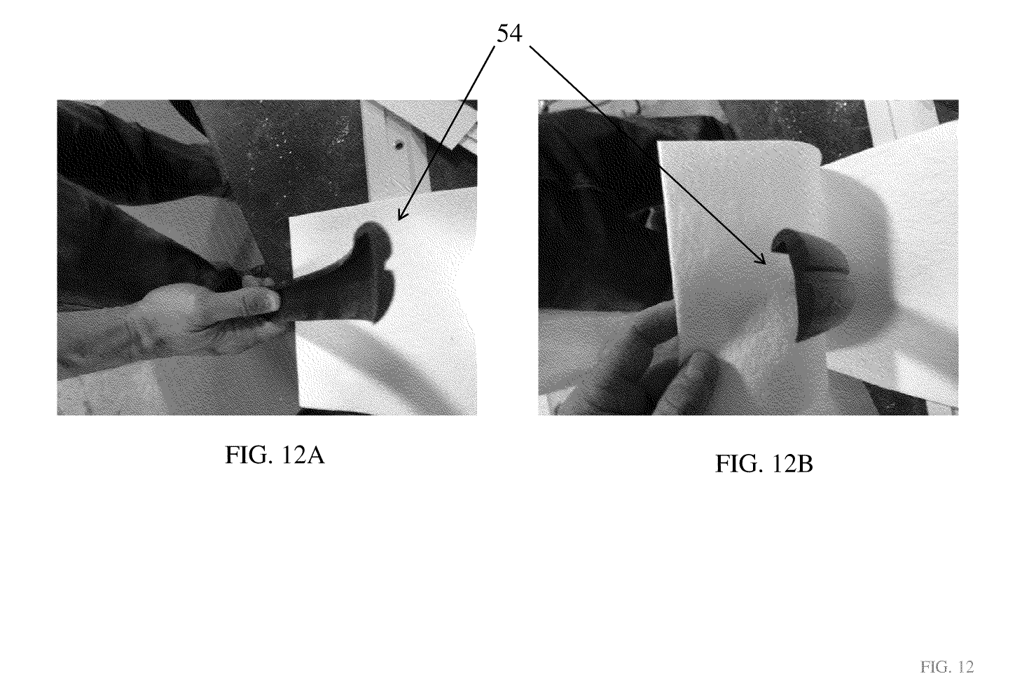

FIG. 10 illustrates a cross section of one embodiment of the window assembly 10 showing the unified roof component 12 transition joint with the forward transition 18, comprising the H section 16. In certain exemplary embodiments, these H Sections 16 are extrusions which comprise upper 50 and lower 52 internal flanges, further comprising an upper outer flange 50A, a upper inner flange 50B, a lower outer flange 52A, and a lower inner flange 52B. In these embodiments, the various flanges 50A, 52A, 50B, 52B of the H sections 16 may comprise excess clearance around the forward transition 18, such that a wedged shaped member (shown in FIG. 11) may be inserted between the inside surface of the forward transition 18 or unified roof component 12 and the inside surface of the H Section flange 50, 52 thus forcing the transition or component to be tightly flush with the outer flanges 50A, 52A. In these embodiments, the outer flanges 50A, 52A may also be relatively shorter than the internal flanges 50B, 52B so as to allow any water infiltration to exit on the external side. In the embodiment shown in FIG. 10, a vinyl “wedge” insert may also be installed, which is described in reference to FIGS. 11-12.

In the embodiments of FIGS. 11-13, a pair of “wedge” inserts 54, 56 are shown, which (as described above) can be driven on the inside of the H section 16 between the unified roof component 12 or the forward transition 18 and the upper 50B or lower 52B internal flanges of the H Section 16, respectively. In certain exemplary embodiments, stepped ridges on the inside surface of the internal flanges of the H-section can be utilized to increase the frictional resistance of the wedge shaped member, such that it is more difficult to remove or dislodge. In certain embodiments, these wedge shaped members 54, 56 may be comprised of rubber, vinyl, or some other material. In various embodiments, hook type features can be utilized on the internal flanges 50B, 52B of the H section, thus allowing the use of pliers or a similar tool to aid in providing additional force when inserting or replacing the wedge 54, 56.

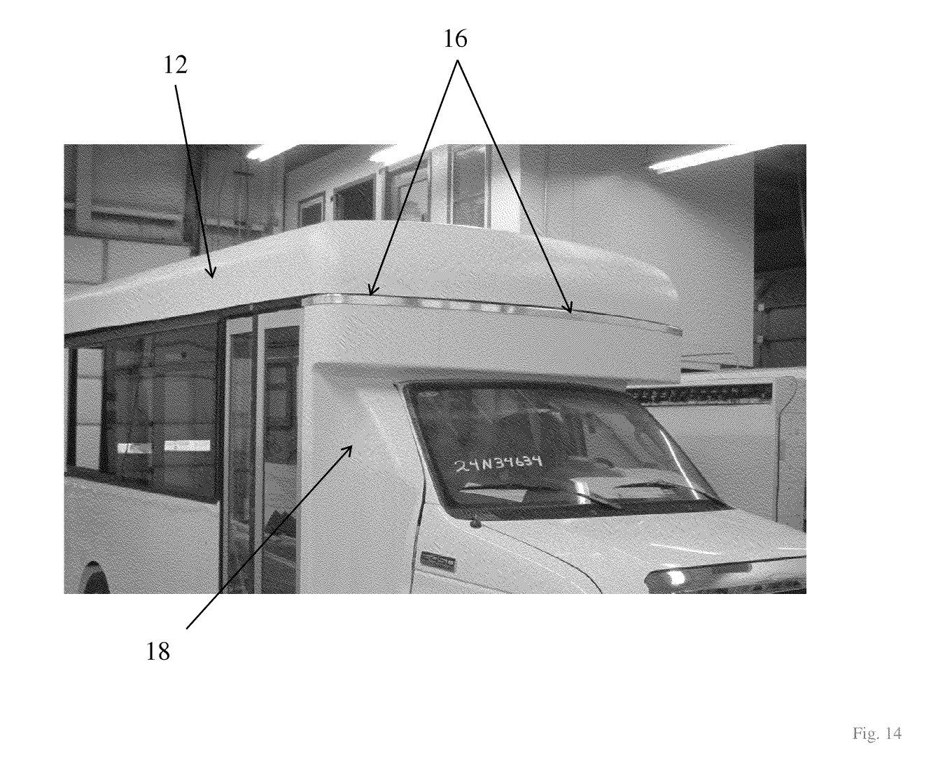

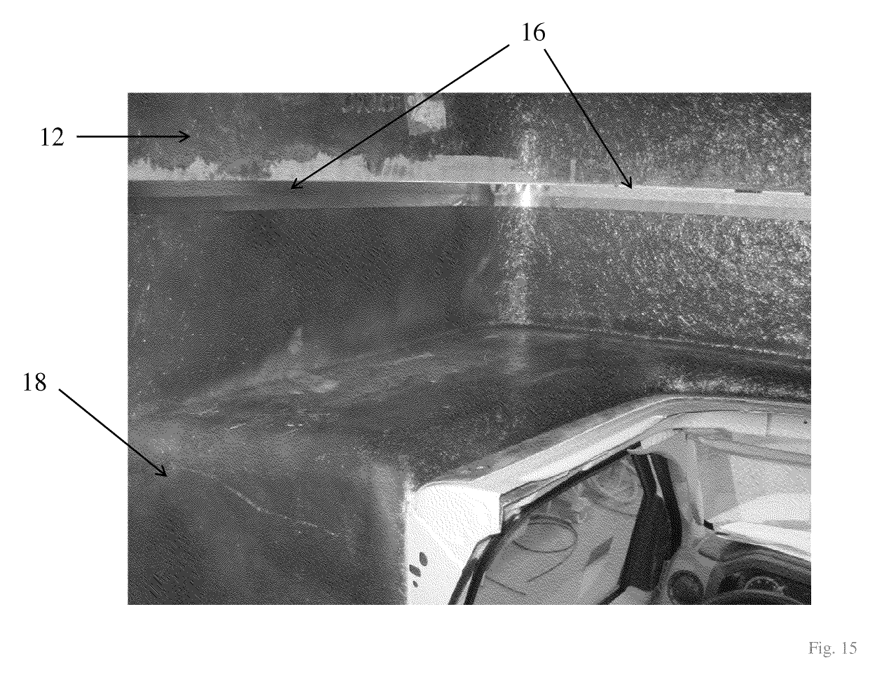

FIG. 14 depicts the H Section fitted between the unified roof component 12 and forward transition 18 on a vehicle. FIG. 15 depicts an internal view of the vehicle showing the H Section 16 fitted between the unified roof component 12 and forward transition 18. In certain embodiments, a combination of screws and/or adhesives may be used to strengthen the joint. Other implementations and embodiments are of course possible.

Turning to the window units in greater detail, in certain exemplary embodiments of the window assembly 10 shown in FIGS. 16-19, a key aspect involves modular window units that can be assembled separately from the vehicle and then installed easily. In these embodiments, the modular window units 100 can be installed on the frame, mounted between the sidewall skin and unified roof component. In certain embodiments, the window assembly comprises similar extrusions to those used in coordination with the fiberglass transition which may be specifically adapted to accommodate easy installation and removal of the window units. In certain embodiments, these extrusions are components of these modular window frames or modular window openings.

In certain embodiments, U-shape vertical extrusions can be utilized to allow the window assembly 100 to be placed onto the vehicle body frame, encapsulating the frame with sufficient clearance for the application of adhesives bonding the window frame to the vehicle frame structure, as discussed herein.

As shown in FIG. 16, certain embodiments generally comprise a modular window assembly 100 further comprising top 102 and bottom 104 window joints adjoining the assembly 100 and the unified roof component 106 and skin 110, respectively. In the embodiment shown in FIGS. 16-19, each assembly also comprises one or more window panes 112, 114, separated by a mullion 116. In certain embodiments, and as also described herein, flat panel glass is installed with automotive urethane. Other implementations and embodiments are of course possible.

In certain exemplary embodiments, at least one of the windows is a tipout window pane 112. In these embodiments the top window joint 102 comprises a tipout window hinge 108. In certain escape window assemblies, the entire modular window assembly 100 can swing out, though in typical exemplary embodiments the top pane 112 is the tipout pane. In certain exemplary embodiments of the window assembly, bonded glass is utilized to improve the strength of the windows and decrease interior noise.

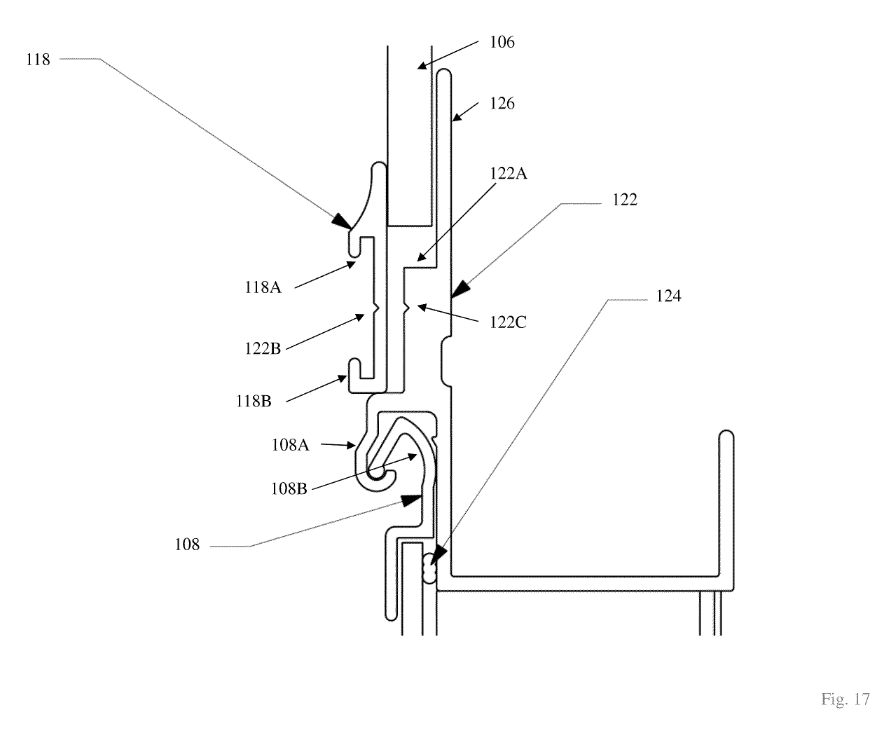

FIG. 17 shows a detailed view of the top window joint 102. Exemplary embodiments may also comprise a hinge feature 108 as part of the top window extrusion, thus allowing addition of hinged vent or escape windows. Certain embodiments further comprise a clamping extrusion 118, a top window extrusion 122, and at least one window seal 124. As shown in FIG. 16, in these embodiments, the clamping extrusion 118 and tipout window hinge 108 allow for easy placement and removal of the window assembly 100. As is shown in detail in FIG. 17, the hinge 108 comprises a fixed pivot region 108A and moving D-flange 108B. As would be apparent to one of skill in the art, many other configurations are possible.

As shown in detail in FIG. 17, in certain embodiments, the top window extrusion 122 comprises an upper window flange 126 on the top edge of the window assembly which acts as a retainer for the inner roof skin 106 of the vehicle. In certain embodiments, the clamping extrusion 118 is mounted externally to the upper window flange 126 located on the top edge of the window assembly and top window extrusion 122 to allow a vehicle roof flange 106 to overlap, thus providing a shingle effect for water infiltration resistance, as is shown in FIG. 17.

In certain embodiments, the top flange has a ledge 122A to position the vehicle roof flange in the correct position. In various embodiments, the top window extrusion 122 may be of sufficient thickness to allow threaded fasteners to be added to hold a clamping extrusion 118 tight to the vehicle roof flange 106 by way of the entry points 122B, 122C, thus clamping the roof flange 106 between the top window flange 126 and the clamping extrusion 118. In certain embodiments, the clamping extrusion may have a further recessed area 118A, 118B where screws are used, thus allowing later application of a plastic strip into the recesses 118A, 118B to cover the screw heads to improve leak resistance and appearance, as would be apparent to one of skill in the art.

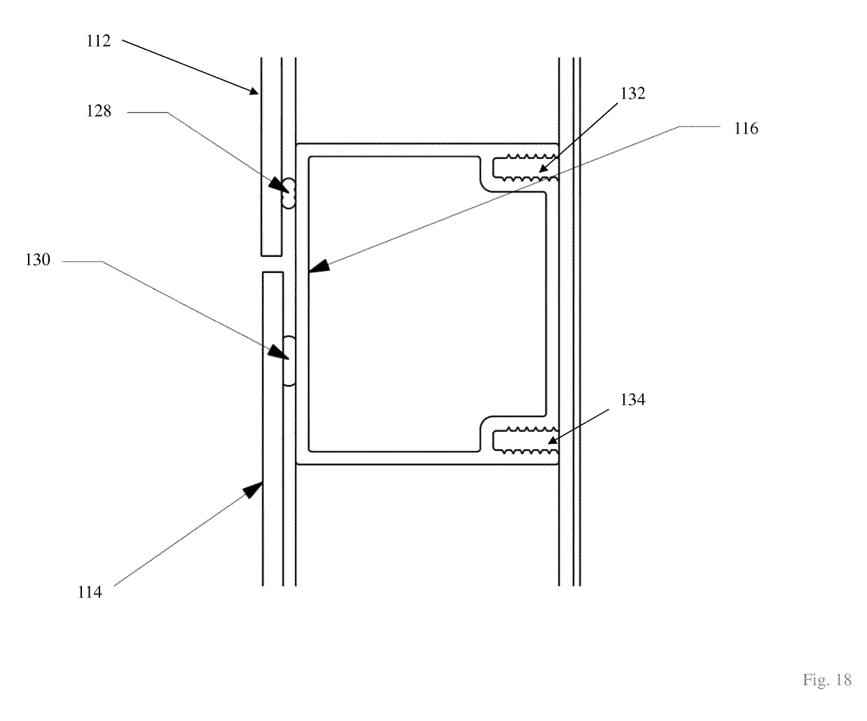

FIG. 18 shows a detailed cross-section of the mullion 116 set between the panes 112, 114. In certain embodiments, the panes 112, 114 may be various affixed to the mullion 116 by way of a variety of seals 128, 130. Various embodiments may further comprise additional features to facilitate the tipping out of the top pane 112, including a latching mechanism and linkage (not shown) operationally coupled to the pane 112 and frame so as to facilitate limited opening of the pane from the hinge 108. Various threaded fastener openings 132, 134 may also be provided which may provide anchoring means for the linkage and latch assembly, as would be apparent to one of skill in the art.

As shown in FIG. 19, in certain embodiments the window assembly also comprises a lower window extrusion 136 comprising a lower window flange 136A which couples with the sidewall 110. This extended flange 136A allows overlap with the vehicle skin below the window providing a shingle effect for water infiltration resistance. An adhesive window seal 138 may also be utilized to affix a window pane 114 to the lower window extrusion 136. In embodiments featuring an escape window, a seal may be utilized, while adhesive can be used in other tipping windows. A fastener opening 140 can also be provided for attachment. Certain embodiments also utilize an aluminum angle which attaches to the window and provides a trim cover capable covers the sidewall gap between the sidewall (not shown).

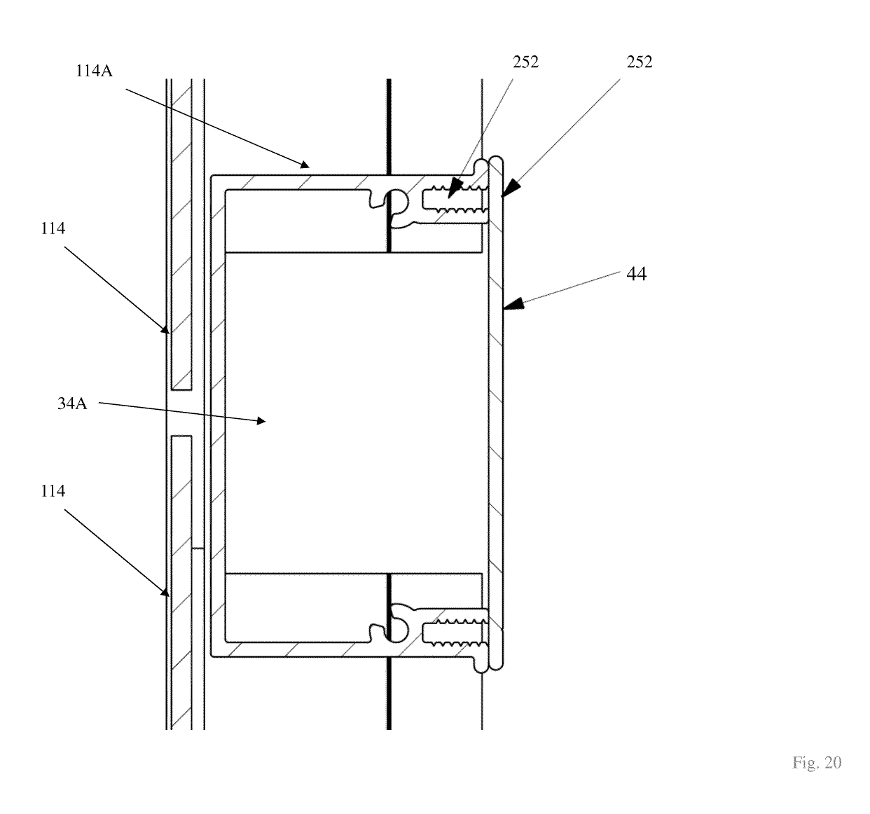

As shown in FIG. 20, in certain embodiments, the window panes 114, 114 are set in vertical window extrusions and covered with inner caps 44. These inner caps (also shown in FIGS. 7B-7D) may be attached to the vertical window extrusion and act to enclose 34A the steel vertical roll cage tube. In certain embodiments, the inner caps 44 may also be utilized to attach to the vertical window extrusions 114A on the inside surface by way of an inner cap 44, thus encapsulating the vertical window extrusion 114A holding the panes 114, 114 in position while any adhesives cure and providing additional mechanical strength and improving the appearance of the window assembly from within the vehicle. Certain embodiments comprise one or more slots as a part of the vertical window extrusions and incorporate saw tooth type surfaces 252 designed to allow screws to be used to attach the inner cap 44. In certain embodiments, the inner cap may be about 0.09″ thick and 3.2″ wide. Other implementations and embodiments are of course possible.

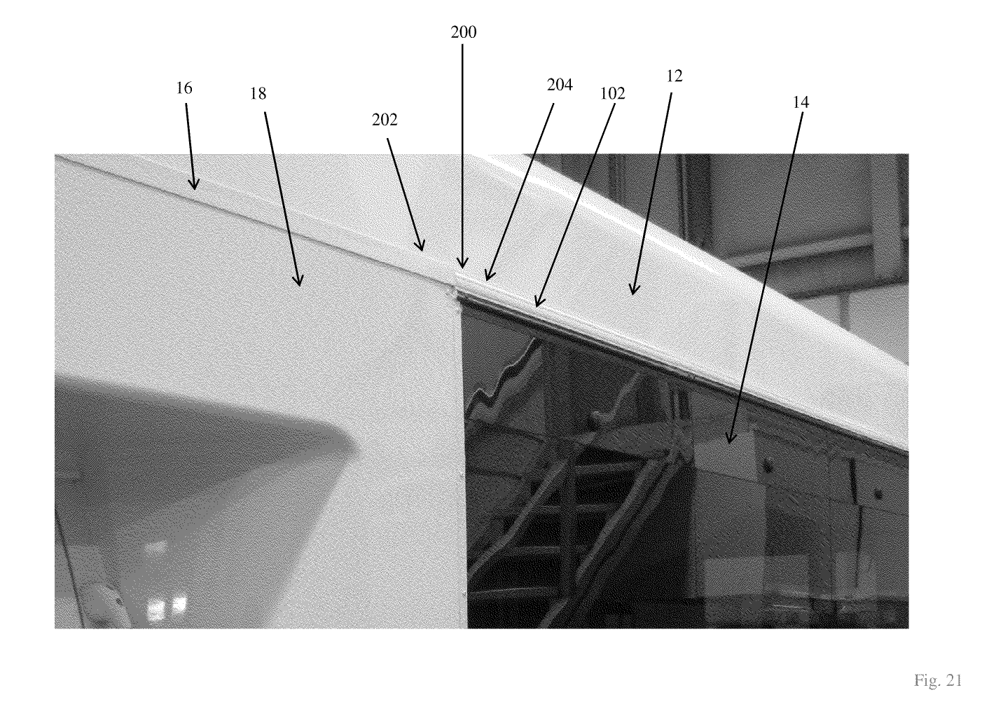

FIG. 21 shows the transition 200 from the H section 16 of the forward transition region 18 to the window assembly 14 region joint 102. The H section 16 region couples with the top window joint 102 at a unified joint 200 and may further comprise an overlap system 202, in which the unified roof component 12 overlaps the window assembly 100 which in turn overlaps the sidewall (not shown). A similar window assembly overlap system 204 may be present above the window assembly, as described in relation to the clamping extrusion 118 in FIG. 17.

Although the present invention has been described with reference to preferred embodiments, persons skilled in the art will recognize that changes may be made in form and detail without departing from the spirit and scope of the invention.

What is claimed is:

1. A window assembly for a passenger vehicle comprising:
a. a generally rectangular unified roof component having front and back ends;
b. at least one window joint; and
c. at least one modular window unit further comprising a top and bottom;
wherein the generally rectangular unified roof component is fixedly attached to the top of the at least one modular window frame by way of the window joint.

2. The window assembly of claim 1, further comprising a passenger vehicle frame and chassis, wherein the assembly is fixedly attached to the frame of the passenger vehicle.

3. The window assembly of claim 2, further comprising a generally planar sidewall skin.

4. The window assembly of claim 2, further comprising a H section joint and forward transition region, wherein the transition is fixedly attached to the chassis.

5. The window assembly of claim 4, wherein the H section joint is disposed between the unified roof component and the transition region.

6. The window assembly of claim 5, further comprising outer and inner flanges, wherein the outer flanges are generally shorter than the inner flanges so as to allow any water infiltration to exit on the external side of the passenger vehicle.

7. The window assembly of claim 3, wherein the modular window units are configured to be assembled separately from a passenger vehicle and installed on the frame, mounted between the sidewall skin and unified roof component.

8. The window assembly of claim 7, wherein the at least one window joint comprises top and bottom window joints.

9. The window assembly of claim 8, further comprising a plurality of window panes and a mulling, wherein the window panes are disposed above and below the mulling and into the top and bottom window joints during installation.

10. A passenger vehicle comprising:
a. a chassis;
b. a frame mounted on the chassis;
c. a generally rectangular unified roof component further comprising front and back ends and side portions;
d. a top window joint;
e. a bottom window joint;
f. a sidewall; and
g. at least one modular window unit further comprising a top and bottom;
wherein at least one modular window unit is disposed between the sides of the unified roof component and sidewalls by way of the top window joint and bottom window joint.

11. The passenger vehicle of claim 10, further comprising a H section joint and forward transition region, wherein the transition is fixedly attached to the chassis.

12. The passenger vehicle of claim 11, wherein the H section joint is disposed between the unified roof component and the transition region.

13. The passenger vehicle of claim 12, further comprising outer and inner flanges, wherein the outer flanges are generally shorter than the inner flanges so as to allow any water infiltration to exit on the external side of the passenger vehicle.

14. The passenger vehicle of claim 10, wherein the at least one modular window unit is configured to be assembled separately from a passenger vehicle and installed on the frame, mounted between the sidewall and unified roof component.

15. The passenger vehicle of claim 10, further comprising a plurality of window panes and a mulling, wherein the window panes are disposed above and below the mulling and into the top and bottom window joints during installation.

16. A system for assembling a passenger vehicle, comprising:
a. a passenger vehicle comprising:
i. a chassis;
ii. a frame;
iii. a generally rectangular unified roof component further comprising front and back ends and side portions;
iv. a top window joint;
v. a bottom window joint;
vi. a sidewall; and
vii. at least one modular window unit further comprising a top and bottom;
b. mounting the unified roof component on the frame such that the at least one modular window unit is disposed between the sides of the unified roof component and sidewalls by way of the top window joint and bottom window joint.

17. The system for assembling a passenger vehicle of claim 16, further comprising a H section joint and forward transition region, wherein the transition is fixedly attached to the chassis.

18. The system for assembling a passenger vehicle of claim 17, wherein the H section joint is disposed between the unified roof component and the transition region.

19. The system for assembling a passenger vehicle of claim 18, further comprising outer and inner flanges, wherein the outer flanges are generally shorter than the inner flanges so as to allow any water infiltration to exit on the external side of the system for assembling a passenger vehicle.

20. The system for assembling a passenger vehicle of claim 16, wherein the at least one modular window unit is configured to be assembled separately from a system for assembling a passenger vehicle and installed on the frame, mounted between the sidewall and unified roof component.
